(19) United States
(12) Patent Application Publication
(10) Pub. No.: US 2015/0020995 A1
(43) Pub. Date: Jan. 22, 2015

(54) SLIM MOBILE HYDRAULIC FLUID COOLING ASSEMBLY

(71) Applicant: GARDNER DENVER, INC., Wayne, PA (US)

(72) Inventor: Travis Austin MERRILL, Fowler, IL (US)

(21) Appl. No.: 13/944,298

(22) Filed: Jul. 17, 2013

(51) Int. Cl. F28D 1/02; F15B 1/26

(52) U.S. Cl. CPC F28D 1/024; F15B 1/26
USPC 165/41

(57) ABSTRACT

A mobile hydraulic cooling assembly has a hydraulic fluid reservoir with a second interior surface offset from a first interior surface. The portion of the second surface offset is not opposite any of the first interior surface in the vertical direction. An air chamber, into which air passes into or out of through a heat exchanger, has an angled exterior surface formed from the reservoir which delimits the air chamber. A fill entry closure which covers a fill entry into the reservoir is accessible by the hands of an operator when a moveable closure of the assembly is in an open position. At least two reservoir portions delimiting a hollow of the reservoir overlap a bottom facing surface and bottom of a truck rail when the cooling assembly is mounted to the truck rail.

### FIELD

The present invention concerns a slim mobile hydraulic cooling assembly for mounting on a frame rail of a truck.

### BACKGROUND

Trucks, such as those that trail tanks, use hydraulic fluid to perform work such as running hydraulic motors on the truck to convey material. As the hydraulic fluid performs work, the fluid heats up. To cool the fluid and to keep it from overheating, a truck will have a mobile hydraulic fluid cooling assembly. The assembly will usually be mounted on the frame rail of the truck.

A known cooling assembly includes a heat exchanger; a fan; a fan motor coupled to the fan; a hydraulic fluid reservoir; a hydraulic fluid filter; and hydraulic fluid conduits. The conduits typically include flexible hoses and fittings to couple the hoses as needed to the heat exchanger; filter and control block. If the fan motor is hydraulically driven, some of the hoses would be coupled to the fan motor by fittings. The assembly, in connection with the heat exchanger and other structure of the assembly, forms an air-box into which air is drawn by the fan through the heat exchanger and exhausted from the air-box to atmosphere. The assembly also includes structure to carry the above items and mount the above items to the truck frame rail.

In operation a known cooling assembly, as described above with a hydraulic fan motor, generally operates as follows. The fluid, after it performs work, now called low pressure fluid is routed, by way of a return conduit into the control block. The return conduit which can include a hose and fitting, is connected to the control block by the fitting. The fitting is coupled to the block at a return port opening into the block. The fluid from the control block passes into the heat exchanger. A hose forms part of the passage. As the fluid passes through the heat exchanger, it is cooled by air being drawn through the heat exchanger into the air-box by the fan. The air is exhausted from the air-box by the fan to atmosphere. The fluid, after it exits the heat exchanger enters a hose. Downstream of the hose is a filter which receives the fluid after it has passed through the hose. The fluid passes through the filter. After the fluid passes through the filter it is emptied into the reservoir. From the fluid reservoir, fluid is drawn out of the reservoir by a pump. The fluid is drawn into the pump and is then again pressurized by the pump to perform work. The fluid, after it performs work, is then recirculated, as described above, through the heat exchanger and back to the reservoir.

Some of the fluid as it is pressurized by the pump, but before it performs work, is routed to the hydraulic fan motor. A bypass conduit routes the fluid, high pressure fluid, from a high pressure line, to the control block. Downstream of the control block, the fluid is routed through a hose into the fan motor. The fluid exits the fan motor. After the fluid exits the fan motor it enters a hose. After it exits the hose it enters the filter. After the fluid passes through the filter, it is emptied into the reservoir.

### SUMMARY

An embodiment of the invention includes a mobile hydraulic fluid cooling assembly having a hydraulic fluid reservoir with a second interior surface offset from a first interior surface. The portion of the second surface offset is not opposite any of the first interior surface in a vertical direction. An air chamber, wherein air passes into or out of through a heat exchanger, has an angled exterior surface which forms part of the reservoir and which delimits the air chamber. A fill entry closure, which covers a fill entry into the reservoir, is accessible by the hands of an operator when a moveable closure of the assembly is in an open position. A first curved wall of a frame of the cooling assembly is proximate a first fitting forming a first suction port of the cooling assembly. The first suction port is at a first side portion of the reservoir. At least two portions delimiting a hollow chamber of the reservoir overlap a bottom facing surface and bottom of a truck rail when the cooling assembly is mounted to the truck rail

### BRIEF DESCRIPTION OF DRAWINGS

FIG. 1 is a top, front, left sided isometric view of a mobile hydraulic cooling assembly embodying the features of the present invention.

FIG. 2 is a bottom, front, right sided isometric view of the mobile cooling assembly of FIG. 1.

FIG. 3 is a front view of the mobile hydraulic cooling assembly of FIG. 1.

FIG. 4 is a front view of the mobile hydraulic cooling assembly of FIG. 1 with the heat exchanger and the closure, moveable from a closed to an open position, removed.

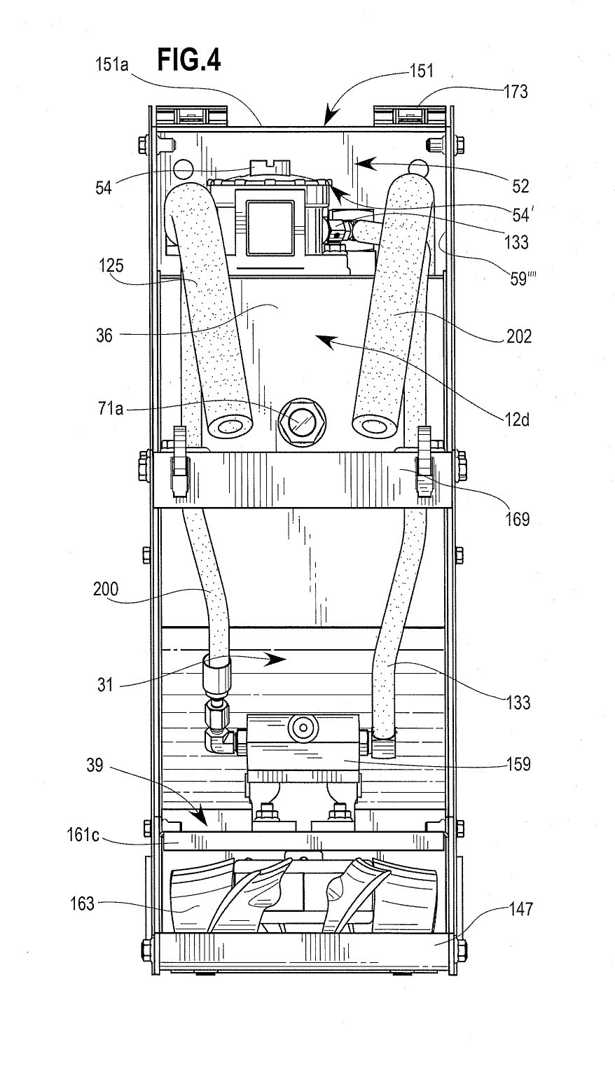

FIG. 5 is a rear view of the mobile hydraulic cooling assembly of FIG. 1.

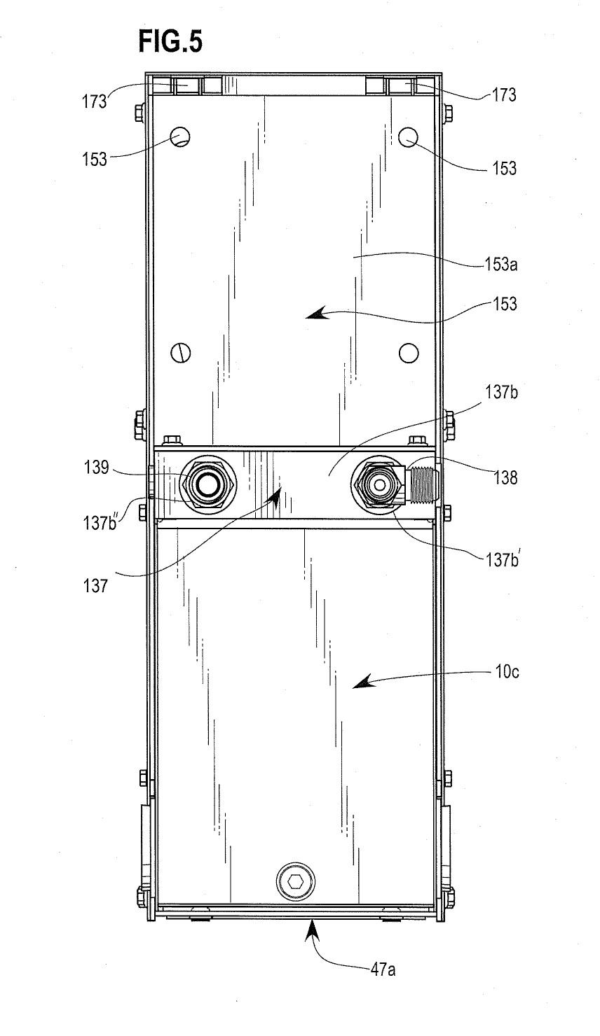

FIG. 6 is a rear view of the mobile hydraulic cooling assembly of FIG. 1 with the frame mount and uprights and cross member removed.

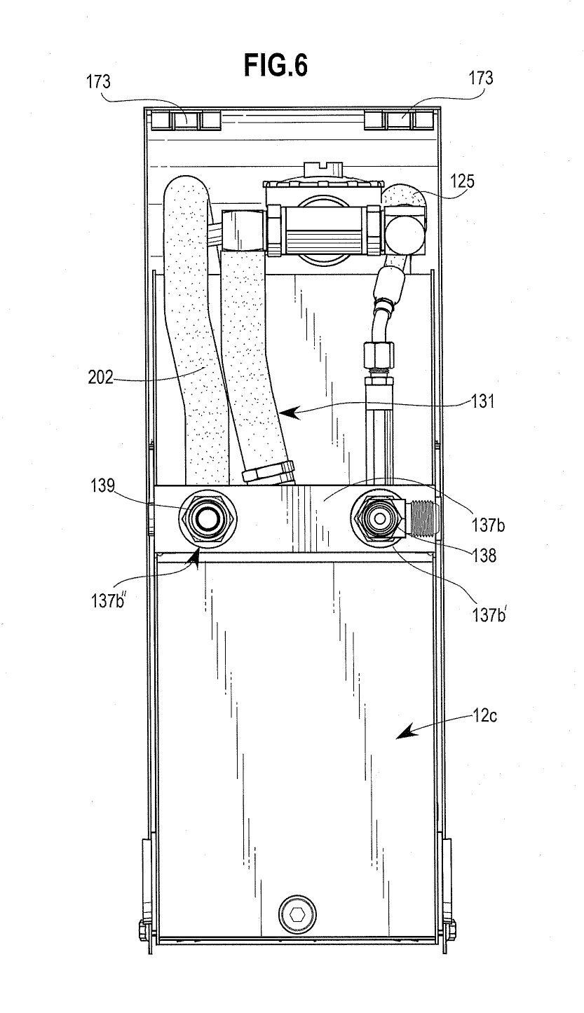

FIG. 7A is a right sided view of the assembly of FIG. 1 with the assembly first side panel removed.

FIG. 7B is a right sided view of the assembly of FIG. 1 with the assembly first side panel and the reservoir first side portion removed; the plug for the suction port in the shown side portion has been removed.

FIG. 7C is a blown-up sectional view of the assembly reservoir shown in FIG. 7B exclusive of the reservoir first and second side portions.

FIG. 8A is a left sided view of the assembly of FIG. 1 with the assembly second side panel removed.

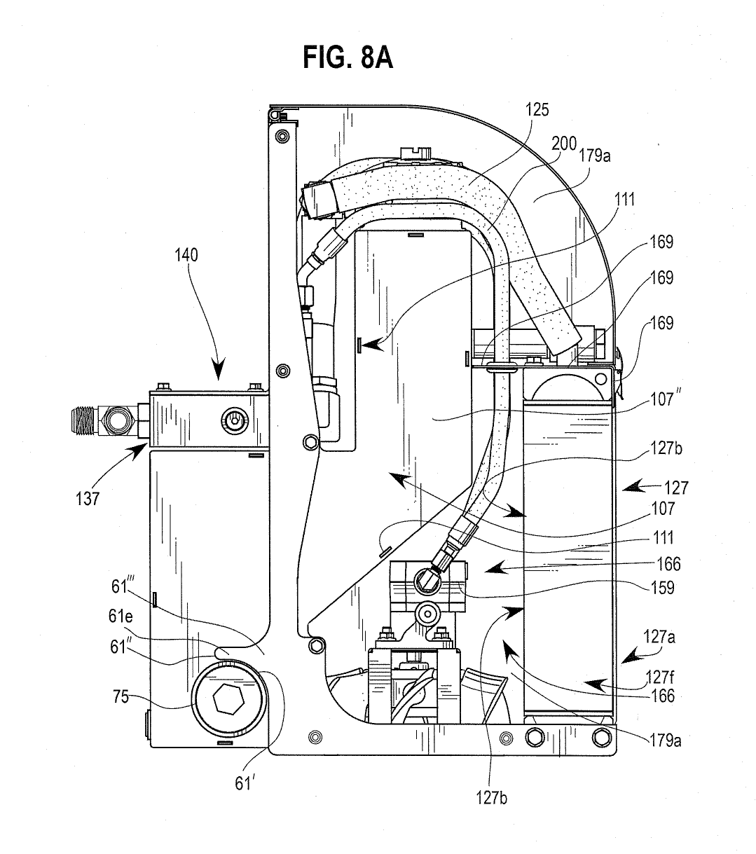

FIG. 8B is a left sided view of the assembly of FIG. 1 with the assembly second side panel removed and the reservoir second side portion removed; the plug for the suction port in the shown side portion has been removed.

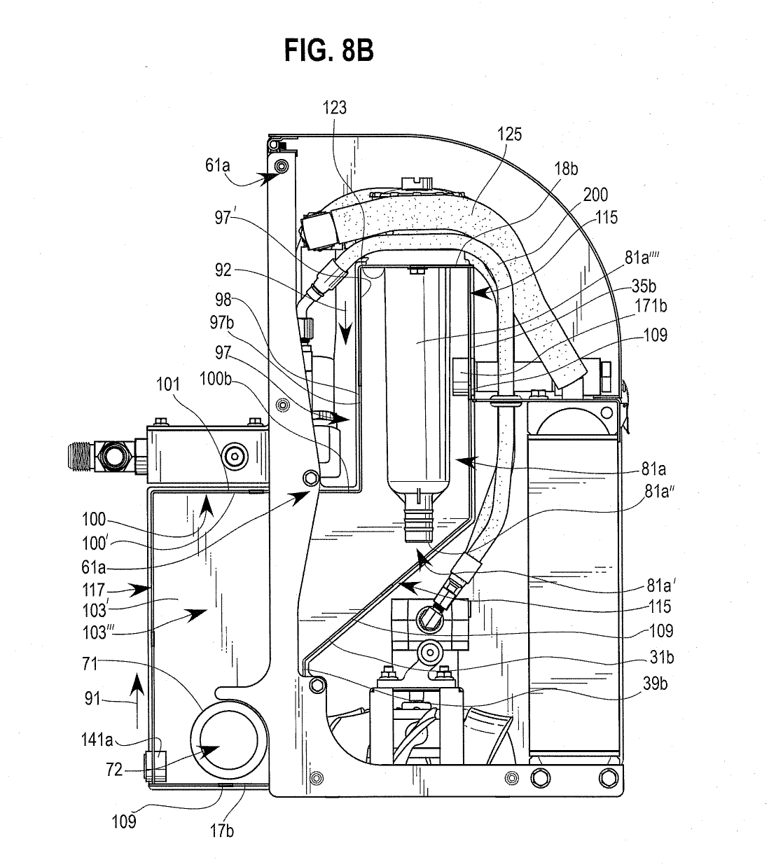

FIG. 9A is an isometric view of the frame of the mobile hydraulic cooling assembly of FIG. 1 carrying the fan cover, and exclusive of other components of the cooling assembly.

FIG. 9B is a blown-up isometric view of the detail area of the frame uprights shown in FIG. 9A.

FIG. 10 is an isometric view of the reservoir of the mobile hydraulic cooling assembly of FIG. 1 carrying the filter; the reservoir has been removed from the rest of the assembly and the plug from the shown suction port has been removed.

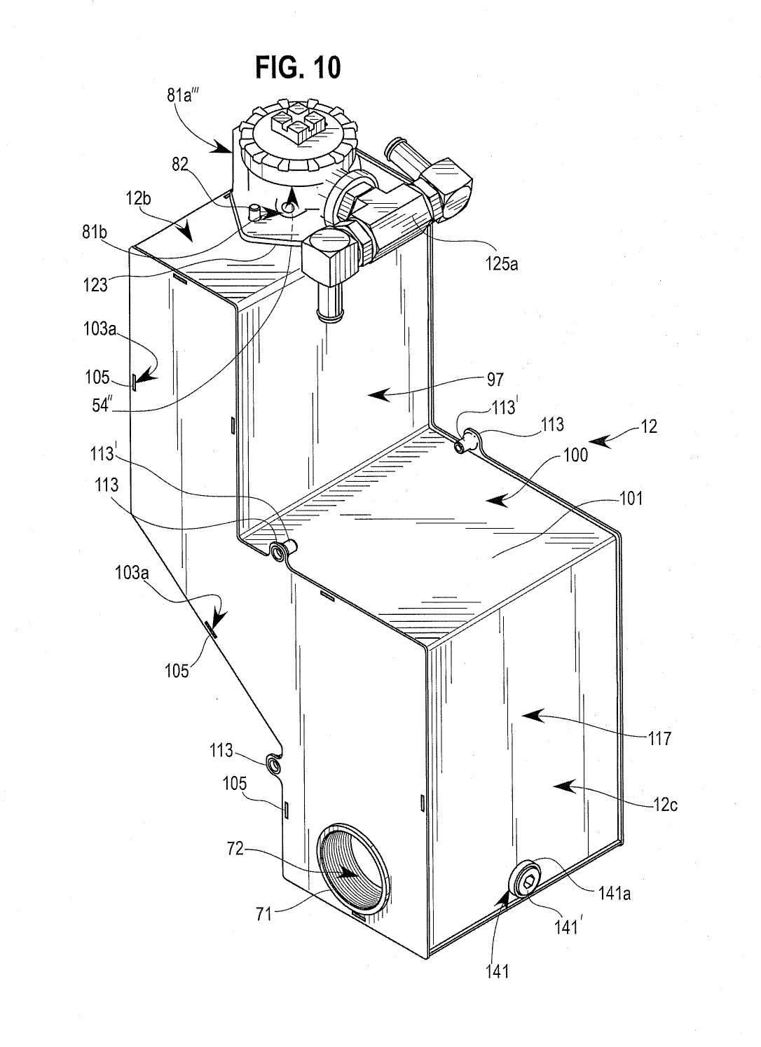

FIG. 11 is a schematic view of the hydraulic cooling assembly of FIG. 1 coupled to a truck frame rail.

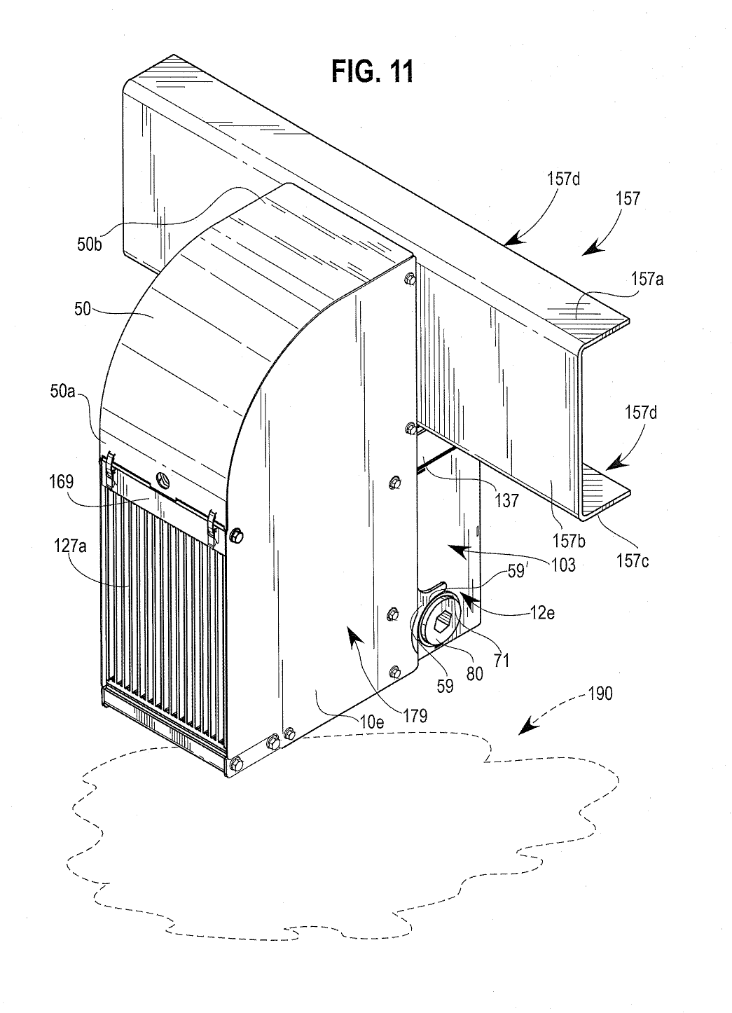

FIG. 12A is an isometric right sided front view of the heat exchanger of FIG. 3.

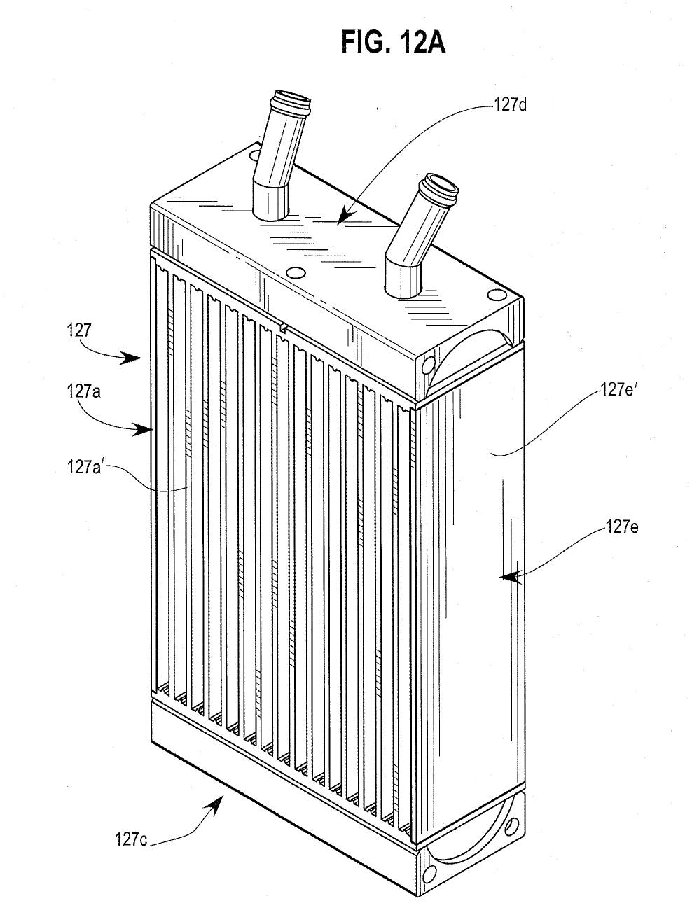

FIG. 12B is an opposite side isometric rear view of the heat exchanger of FIG. 12A.

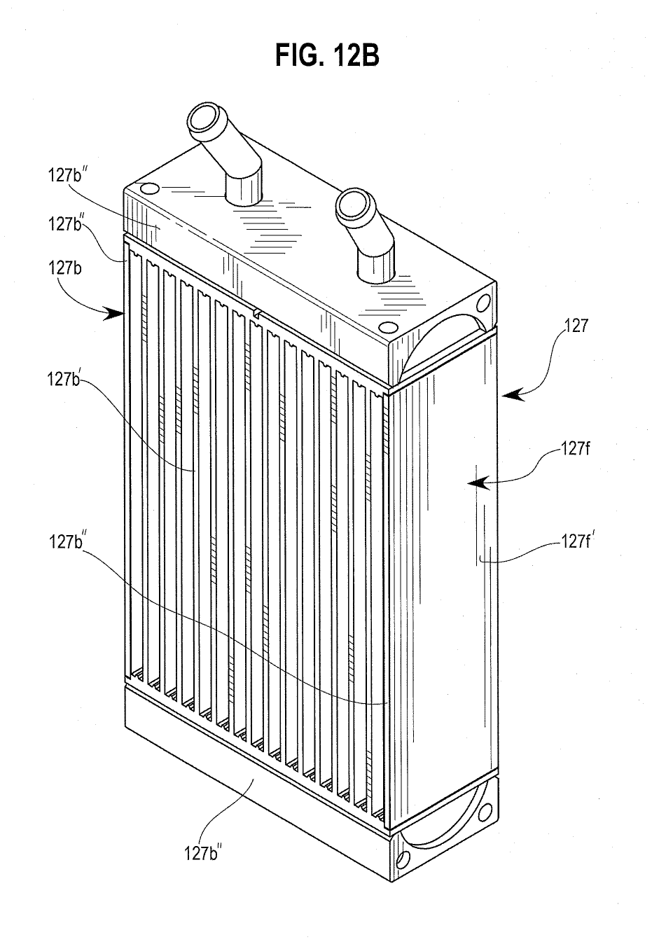

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, and is not intended to limit the invention to the specific embodiment illustrated.

The mobile hydraulic cooling assembly 10 embodying the present invention has a hydraulic fluid reservoir 12. The reservoir has a hollow chamber 15 defined by portions of the reservoir which include a first portion 17 and a second portion 18. A first interior surface 20 of the first portion 17 and a second interior 22 surface of the second portion 18 delimit the hollow chamber 15. The first interior surface 20 delimits a first interior end 20′ of the reservoir and the second interior surface 22 delimits a second interior end 22′ of the reservoir. The reservoir has a distance 25 measured in a vertical direction 91 from the first interior end 20′ to the second interior end 22′. The vertical distance is an internal height of the reservoir. The vertical distance separates the first 20 and second 22 interior surfaces. The greatest vertical distance separating the internal surfaces is a maximum vertical distance. The distance 25 is a maximum vertical distance. A longest straight line 27 extending from the first interior surface 20 to the second interior surface 22 intersects a line 25′ drawn along the vertical direction 91 at an angle greater than 90 degrees and less than 180 degrees. The angle is preferably between 141° and 155°. It is shown as 148°. A shortest straight line 29 from the first interior surface 20 to the second interior surface 22 intersects the line 25′ drawn along the vertical direction 91 at an angle of greater than 90 degrees and less than 180 degrees. The angle is preferably between 172° and 176°. It is shown as 174°. The angles are determined going in the counter clockwise direction and starting at the longest straight or shortest straight line in the positive X direction. The 0,0 coordinates are at the intersection of the lines.

The reservoir has a further portion 31, referred to below as an eighth portion, with an interior surface 31′ delimiting the hollow chamber 15. The further portion 31 is angled relative to the second portion 18 going in a clockwise direction and starting from a line drawn along or parallel to the second interior surface 22 at an angle of less than 90 degrees; the angle is preferably between 30 and 50, and is shown as 40. The further portion 31 is angled relative to the first portion 17 going in a counterclockwise direction and starting from a line drawn along or parallel to the first interior surface 20 at an angle of greater than 90 degrees and less than 180 degrees; the angle is preferably between 130 and 150, and is shown as 140.

The reservoir has a third interior surface 33′ delimiting the hollow chamber 15 and delimiting a third interior end 33″ of the reservoir. The reservoir has a fourth interior surface 35′ delimiting the hollow chamber 15 and delimiting a fourth interior end 35″ of the reservoir. The reservoir has an interior depth. The depth is a horizontal distance 37 that separates the third and fourth interior surfaces 33′, 35′. The greatest horizontal distance separating the third and fourth interior surfaces 33′, 35′ is a maximum horizontal distance. The distance 37 is a maximum horizontal distance. The term horizontal, as used herein with respect to the reservoir, is relative to the ground when the reservoir's first exterior surface 21 faces the ground.

The reservoir has a fifth interior surface 39′ delimiting the hollow chamber 15. A shortest straight line 41 drawn between the fifth interior surface 39′ and a portion the third interior surface 33′ opposite the fifth interior surface 39′ is Y. The distance Y is less than the interior depth 37 of the reservoir and less than the maximum horizontal distance 37 separating the third 33′ and fourth 35′ internal surfaces. The portion of surfaces 39′ and 33′ opposite each other form part of a sump area 43 of the reservoir.

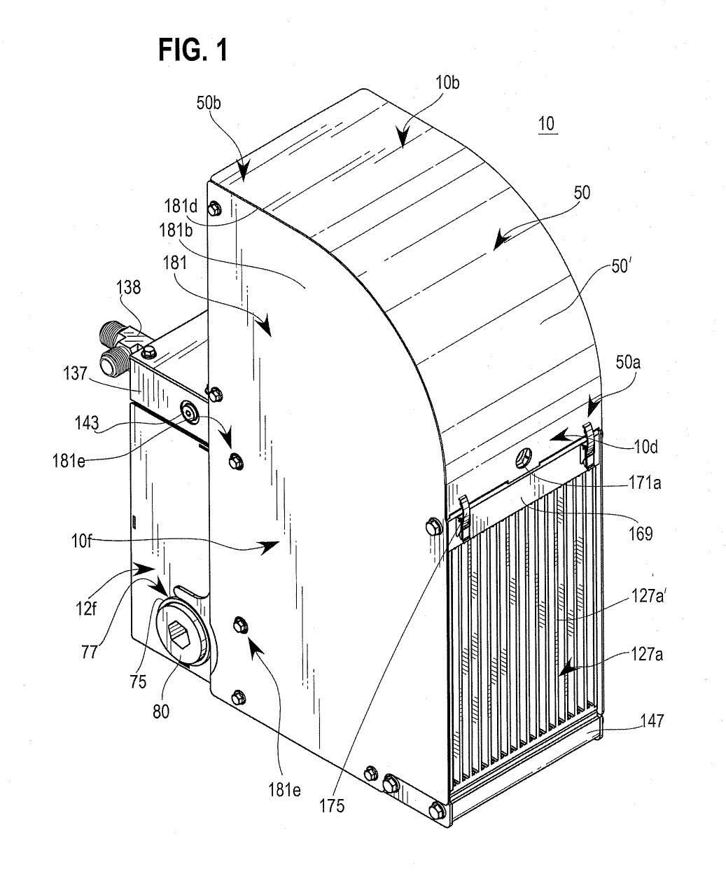

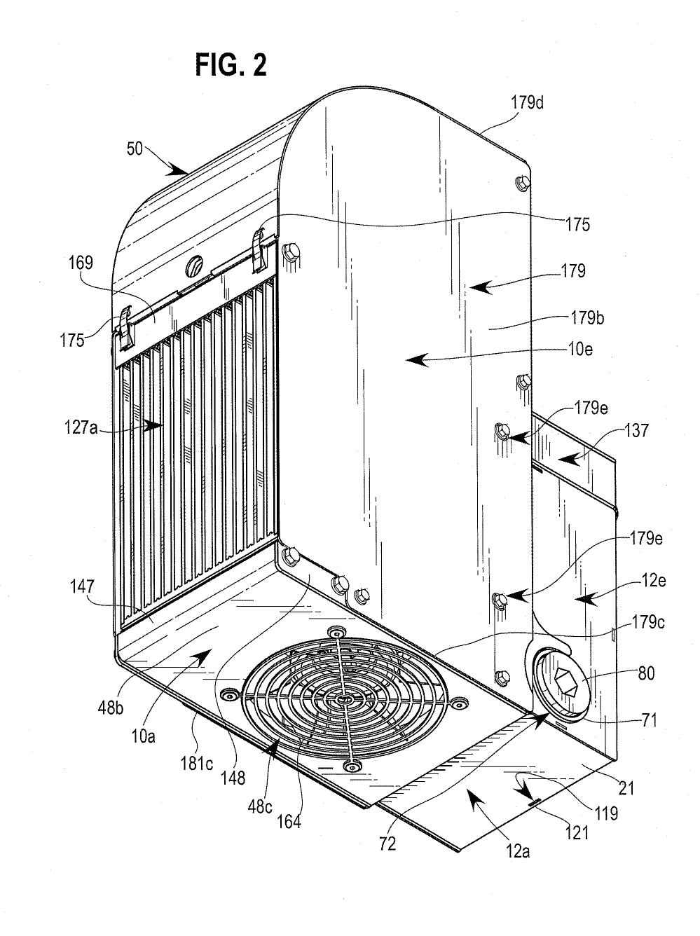

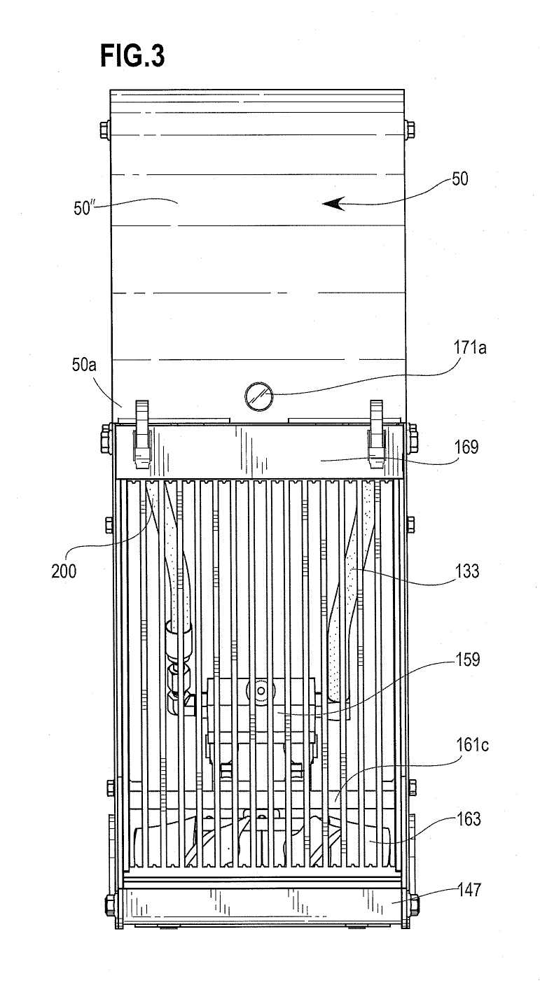

The cooling assembly includes a frame 47 coupled to the reservoir 12. The frame has a first end 47a, second end 47b, third end 47c, and fourth end 47d oriented along the same direction as the first end 10a, 12a, second end 10b, 12b third end 10c, 12c and fourth end 10d, 12d, respectively, of the cooling assembly 10 and the reservoir 12. The frame carries a closure 50 moveable from an open position to a closed position and vice versa. The dashed lines show the closure in the open position. The closure 50 has an interior surface 50″ delimiting an open area 52 going in a direction from the open area 52 to the second end 10b of the assembly and in a direction going from the open area 52 to the fourth end 10d of the assembly. Disposed in the open area is a removable fill entry closure 54 which covers a fill entry 54′ into the reservoir 12. When the closure 50 is in the open position, the open area 52 is open to the environment exterior to the closure 50; the closure 54 of the fill entry 54′ is accessible by the hands of an operator. The operator can move the fill entry closure 54 to an open position and fill the reservoir 12 with hydraulic fluid. The closure 50, when in the closed position, as shown in FIGS. 1, 2 and 3 closes off the open area 52 so it is not accessible by the hands of an operator.

Open areas 58, 60 are delimited by respective frame portions 59, 61 of the frame. Respective curved walls 59′, 61′ delimit each open area 58, 60 in a direction which is along a vector which has a component going towards the second end 47b and component going towards the fourth end 47d of the frame. The vector component going towards the second end 47b goes in the vertical direction 91 and the component going towards the fourth end 47d goes in the first horizontal direction 400. Each open area 58, 60 have a respective opening 58′, 60′ into its respective open area 58, 60. Each opening 58′, 60′ is proximate a surface 59″, 61″ of its respective frame portion 59, 61. The surfaces 59″, 61″ each face away from the fourth end 47d of the frame 47. Each open area 58, 60 also opens through an exterior 59′″, 61′″ and interior 59″″ and 61″″ surface of its respective frame portion 59, 61. A flange 59e, 61e of each frame portion 59, 61, forms part of its respective frame portions 59, 61 curved wall 59′, 61′ and surface 59″, 61″. Each open area 58, 60 is configured to have a respective first aperture line 63, 65 that passes through the respective open area 58, 60 in a first direction without contacting the portion of the frame portion 59, 61 bordering the respective open area. The first direction is perpendicular to the exterior 59′″, 61′″ and interior 59″″, 61″″ surfaces of the respective frame portions 59, 61. Each open area 58, 60 is configured to have a second aperture line 67, 69 that passes into the respective open area 58, 60 in a second direction without contacting the portion of the frame portion 59, 61 bordering the respective open area. The second line 67, 69 of each open area is perpendicular to the first line of each open area. Each curved wall, 59′, 61′ delimiting each open area 58, 60 is generally arcuate. The curved wall 59′ is proximate and may contact a fitting 71 of a respective suction port 72 at a first side portion 103 of the reservoir when the reservoir is coupled to the frame 47; and the curved wall 61′ is proximate and may contact a fitting 75 of a respective suction port 77 at a second side portion 107 of the reservoir when the reservoir is coupled the frame 47. Suction portion 72 is at the first side 103 and is formed by hollow fitting 71 extending through a through opening in side 103; suction portion 77 is at the first side 107 and is formed by hollow fitting 77 extending through a through opening in side 107. Each curved wall 59′, 61′ provides an abutment for its respective fitting 71, 75 to reduce strain on the connection between the fitting 71, 75 and its respective side portion 103, 107 when a respective conduit is coupled to its respective fitting 71, 75. The curved side wall's 59′, 61′ can abut their respective fittings 71, 75 prior to being connected to their respective conduit. Alternatively, there can also be a slight gap between the fitting 71, 75 and its respective curved wall 59′, 61′ until the respective conduit is put under strain. When under strain the respective fitting 71, 75 abut its respective curved wall 59′, 61′.

A filter 81 extends into the reservoir hollow chamber 15. A fluid outlet 81a′ is formed in a housing 81a of the filter 81. An end surface 81a″ delimiting an exterior end of the outlet 81a′ is submerged in the hydraulic fluid in the reservoir 12 when the cooling assembly 10 is under normal operation. The end surface 81a″ is away from the surface of the hydraulic fluid a minimum distance of 13 cm's and a preferred distance of 15 cm. The outlet 81a′ is away from the interior surface of the second portion 18 a preferred distance, taken along a shortest straight, line of 25 cm's and a minimum distance of 22 cm. The end surface 81a′ is a distance, measured in the vertical direction 91, along a longest straight line, spaced from the interior surface 31′ of the portion 31 of 0.5 cm. The distance is preferably a distance between 0.5 and 2 cm.

In more detail the reservoir's first portion 17 first exterior surface 21 faces a direction opposite the direction the first interior surface 20 faces. The first portion 17 is at the first end 12a of the reservoir and a bottom. The first interior surface 20 at the first interior end 20′ delimits the hollow chamber 15 of the reservoir 12 going from the chamber 15 in the direction towards the first end 12a of the reservoir. The first exterior surface 21 forms a first exterior end of the reservoir. The first interior surface 20 and the first exterior surface 21, respectively, each completely lie in a single respective plane and are each planar. The first interior surface 20 delimits an interior bottom of the hollow chamber 15 and interior floor of the reservoir; the first exterior surface 21 delimits an exterior bottom of the reservoir. The first surfaces 20, 21 and first portion 17 are all parallel to horizontal line 37′. The term horizontal, as used herein with respect to the reservoir, is relative to the ground when the reservoir's first exterior surface 21 faces the ground.

The reservoir's second portion 18 has a second exterior surface 23 that faces a direction opposite the direction the second interior surface 22 faces. The second portion 18, second interior surface 22, and second exterior surface 23 are parallel, respectively, to the first portion 17, first interior surface 20, and first exterior surface 21. The first interior surface 20 faces a direction opposite the second interior surface 22. The second portion 18 is at a second end 12b and top of the reservoir. The second interior surface 22 at the second interior end 22′ delimits the hollow chamber 15 of the reservoir 12 going from the chamber 15 in the direction towards the second end 12b of the reservoir 12. The second exterior surface 23 forms a second exterior end of the reservoir. The second interior surface 22 and the second exterior surface 23, respectively, each completely lie in a single respective plane and are each planar. The second interior surface 22 delimits an interior top of the reservoir and interior top of the hollow chamber 15; the second exterior surface 23 delimits an exterior top of the reservoir. The second surfaces 22, 23 and second portion 18 are all parallel to the horizontal line 37′.

The longest straight line 27 extending from the first interior surface 20 to the second interior surface 22 intersects a first line perpendicular to both a first line 85 and a second line 87. The line perpendicular is the vertical line 25′. The first line 85 contacts a least one point on the first interior surface 20 and the second line 87 contacts at least one point on the second interior surface 22. The first line 85 and the second line 87 are two lines of a shape 89 consisting of four lines. The four lines are continuous and the shape has four interior right angles. The lines delimit an interior area circumscribed by the four lines. The interior area is as small as possible without a point on an interior surface of the reservoir delimiting the hollow both falling outside of the interior area and not contacting any of the lines forming the shape.

The second interior end 22′ delimits an interior end of the reservoir spaced furthest away from the first interior end 20′ of the reservoir 12; the distance measured along the first line 25′ perpendicular. The second exterior surface 23 delimits an exterior surface of the reservoir furthest away from the first exterior surface 21 of the reservoir; the distance measured along the same line perpendicular 25′. The distance measured is a maximum vertical distance separating the first and second exterior surfaces. The distance measured is the exterior height of the reservoir. The term vertical, as used herein with respect to the reservoir, is relative to the ground 190 when the reservoir's first exterior surface faces the ground.

The second interior surface 22 is offset from at least a portion of the first interior surface 20 in the first horizontal direction 400. Off-set in the horizontal direction means the portions of the first interior 20 and second interior 22 surfaces offset, are offset such that neither of the portions are opposite each other in the vertical direction 91. In the shown embodiment, the entire second interior surface 22 is off-set from the entire first interior surface 20 in the first horizontal direction 400 such that neither surface is opposite the other in the vertical direction 91. The longest straight line and the shortest straight line extending from the first interior surface to the second interior surface will intersect the second line perpendicular 37′ at an angle, going in the counterclockwise direction and starting from the second line perpendicular greater than 90 degrees and less than 180 degrees. The angle formed with the shortest straight line is 96°; the angle is preferably between 94° and 98°. The angle formed with the longest straight line is 122°; the angle is preferably between 120° and 124°. As always the starting point is in the positive X direction. Again the 0, 0 coordinates are at the intersection. The entire second interior surface 22 faces in a vertical direction 92 opposite the vertical direction 91 the entire first interior surface 20 faces.

The reservoir's third portion 33 has a third exterior surface 34 that faces a direction opposite the direction the third interior surface 33′ faces. The third portion 33 is at third end 33″ and rear of the reservoir. The third interior surface 33′ at the third end 33″ delimits the hollow chamber 15 of the reservoir 12 going from the chamber 15 in the direction towards third end 12c of the reservoir. The third exterior surface 34 delimits a third exterior end of the reservoir. The third interior surface 33′ and the third exterior surface 34, respectively, each completely lie in a single respective plane and are each planar. The third portion 33, the third interior surface 33′, and third exterior surface 34 are, respectively, perpendicular to the first portion 17, first interior surface 20, and first exterior surface 21. The third portion is perpendicular to the second portion 18. The third portion 33 and third surfaces 33′, 34 are perpendicular to the horizontal line 37′. The third portion 33 extends away from the first portion 17 in the first vertical 91 direction towards the second line 87 contacting the second interior surface 22. The third portion 33 extends from an end of the first portion 17 at the third end 12c of the reservoir.

The reservoir's fourth portion 35 has a fourth exterior surface 36 that faces a direction opposite the direction the fourth interior surface 35′ faces. The fourth portion 35 is at a fourth end 12d and front of the reservoir. The fourth interior surface 35′ and the fourth exterior surface 36, respectively, each completely lie in a single respective plane and are each planar. The fourth interior surface at the fourth interior end 35″ delimits the hollow chamber of the reservoir going from the chamber 15 in the direction towards the fourth end 12d of the reservoir. The fourth portion 35, fourth interior surface 35′, and fourth exterior surface 36 are, respectively, perpendicular to the second portion 18, second interior surface 22, and second exterior surface 23. The fourth portion 35 is parallel to the third portion 33 and perpendicular to the first portion 17. The fourth interior surface 35′ faces a direction opposite the direction the third interior surface 33′ faces. At least a portion of the third interior surface 33′ is not opposite, going in the direction 400, the fourth interior surface 35′. The fourth portion 35 and fourth surfaces 35′, 36 are perpendicular to the horizontal 37′. The fourth portion 35 extends away from the second portion 18 in a second vertical direction 92 towards the first line 85 contacting the first interior surface 20. The fourth portion 35 extends from an end of the second portion 18 at the fourth end 12d of the reservoir.

A second line is perpendicular to another first line 93 and to another second line 95. The other first line 93 contacts at least one point on the third interior surface 33′ and the other second line 95 contacts at least one point on the fourth interior surface 35′. The second line perpendicular is the horizontal line 37′. From line 93, line 37′ extends towards line 95 in the first horizontal direction 400. The first line and the second line are two lines of a shape 89 consisting of four lines. The four lines are continuous and the shape has four interior right angles. The lines delimit an interior area circumscribed by the four lines. The interior area is as small as possible without a point on an interior surface of the reservoir delimiting the hollow both falling outside of the interior area and not contacting any of the lines making the shape.

The fourth interior end 35″ delimits an interior end of the reservoir furthest away from the third interior end 33″; the distance measured along the second line perpendicular 37′. The fourth exterior surface 36 delimits an exterior end of the reservoir furthest away from the third exterior end of the reservoir; the distance measured along the same second line perpendicular 37′. The distance measured is also a maximum horizontal distance separating the third 34 and fourth 36 exterior surfaces. The distance measured is the exterior depth of the reservoir 12. The entire third interior surface 33′ faces in a direction opposite the direction the entire fourth interior surface 35′ faces.

The reservoir's fifth portion 39 has a fifth exterior surface 40 that faces a direction opposite the direction the fifth interior surface 39′ faces. The fifth interior surface 39′ delimits the hollow chamber 15 of the reservoir going from the chamber 15 in the direction away from the third end 12c of the reservoir. The fifth interior surface 39′ and the fifth exterior surface 40, respectively, each completely lie in a single respective plane and are each planar. The fifth portion 39, fifth interior surface 39′, and fifth exterior surface 40 are, respectively, perpendicular to the first portion 17, first interior surface 20, and first exterior surface 21. The fifth portion 39 is parallel to the third 33 and fourth 35 portions and perpendicular to the second portion 18. The fifth portion 39 and fifth surfaces 39′, 40 are perpendicular to the horizontal line 37′. The fifth portion 39 extends away from the first portion 17 in the first direction 91 towards the second line 87 contacting the second interior surface 22′. The fifth portion 39 extends from an end of the first portion 17, opposite the end of the first portion 17, from which the third portion 33 extends. At least a portion of the fifth interior surface 39′ is opposite and faces the third interior surface 33′.

The reservoir includes a sixth portion 97 having a sixth interior surface 97′ and a sixth exterior surface 98. The sixth exterior surface 98 faces a direction opposite the direction the sixth interior surface 97′ faces. The sixth interior surface 97′ delimits the hollow chamber 15 of the reservoir 12 going from the chamber in the direction away from of the fourth end 12d of the reservoir. The sixth interior surface 97′ and the sixth exterior surface 98, respectively, each completely lie in a single respective plane and are each planar. The sixth portion 97, sixth interior surface 97′, and sixth exterior surface 98 are, respectively, perpendicular to the second portion 18, second interior surface 22, and second exterior surface 23. The sixth portion 97 is parallel to the third 33, fourth 35 and fifth 39 portions and perpendicular to the first portion 17. The sixth portion 97 and sixth surfaces 97′, 98 are perpendicular to the horizontal line 37′. The sixth portion 97 extends away from the second portion 18 in the second vertical direction 92 towards the first line 85 contacting the first interior surface 20. The sixth portion 97 extends from an end of the second portion 18, opposite the end of the second portion 18, from which the fourth portion 35 extends. At least a portion of the fourth interior surface 35′ is opposite and faces the sixth interior surface 97′. The fifth interior 39′ surface and sixth interior surface 97′ face opposite directions. A distance between the fourth interior surface 35′ and the sixth interior surface 97′, opposite the fourth interior surface 35′, is X. The distance is measured along a shortest straight line between these surfaces. The distance X is less than the interior depth 37 of the reservoir and less than the distance Y between the third 33′ and fifth 39′ interior surfaces.

As measured along the interior height 25 of the reservoir, the sixth portion 97 has a length greater than the fifth portion 39; the fourth portion 35 has a length greater then sixth portion 97; and the third portion 33 has a length greater than the sixth portion 97.

The reservoir includes a seventh portion 100 having a seventh interior surface 100′ and a seventh exterior surface 101. The seventh exterior surface 101 faces a direction opposite the direction the seventh interior surface 100′ faces. The seventh interior surface 100′ delimits the hollow chamber 15 of the reservoir going from the chamber 15 in the direction away from first end 12a of the reservoir. The seventh interior surface 100′ and the seventh exterior surface 101, respectively, each completely lie in a single respective plane and are each planar. The seventh portion 100, seventh interior surface 100′, and seventh exterior surface 101 are perpendicular, respectively, to the sixth portion 97, sixth interior surface 97′, and sixth exterior surface 98. The seventh portion 100 is parallel to the first 17 and second 18 portions and perpendicular to the third 33, fourth 35 and fifth portions 39. The seventh portion 100 and seventh surfaces 100′, 101 are all parallel to the line 37′. The seventh portion 100 extends away from the sixth portion 97 in a direction towards the other first line 93 contacting the third interior surface 33′. Only a portion of the seventh interior surface 100′ is opposite and faces the first interior surface 20. A distance between the seventh interior surface 100′ and the first interior surface 20, opposite seventh interior surface 100′, is Z. The distance is measured along a shortest straight line between these surfaces. The distance Z is less than the interior height 25′ of the reservoir and greater than the distance X between the fourth 35′ and sixth 97′ interior surfaces.

As measured along the interior depth of the reservoir, the length of the first portion 17 is greater than the length of the second first portion 17; the length of the seventh portion 100 is greater than the length of the second portion 18.

The reservoir includes eighth portion 31 having an eighth interior surface 31′ and an eighth exterior surface 32. The eighth exterior surface 32 faces a direction opposite the direction the eighth interior surface 31′ faces. The eighth interior surface 31′ delimits the hollow chamber 15 of the reservoir going in the direction away from of the second end 12b of the reservoir. It also delimits the hollow chamber 15 going in a direction away from the third end 12c of the reservoir. The eighth interior surface 31′ and the eighth exterior surface 32, respectively, each completely lie in a single respective plane and are each planar. The eighth portion 31, eighth interior surface 31′, and eighth exterior surface 32 are angled. The eighth interior surface 31′ is angled relative to the first interior surface 20 at an angle greater than 90 degrees and less than 180 degrees when going in a counterclockwise direction and starting from the a line drawn along or parallel to the first interior surface 20. The angle is more preferably between 130 and 150 degrees. The preferred angle shown is 140 degrees. The eighth interior surface 31′ is angled relative to the second interior surface 22 at an angle of less than 90 degrees when going in the clockwise direction and starting from a line drawn parallel to or along the second interior surface. The angle is more preferably between 30 and 50 degrees. The preferred angle shown is 40 degrees. The eighth interior surface 31′ is angled relative to the first line perpendicular 25′ at an angle of greater than 90 degrees and less than 180 degrees when going in the counterclockwise direction and starting from the eighth interior surface. The angle is more preferably between 120 and 140 degrees. The preferred angle shown is 130 degrees. The eighth interior surface 31′ is angled relative to the second line perpendicular 37′ at an angle of greater than 90 degrees and less than 180 degrees when going in the counterclockwise direction and starting from the second line perpendicular. The angle is more preferably between 130 and 150 degrees. The preferred angle shown is 140 degrees. The starting point when going in the above specified directions is always in the positive X direction. The vertex of the angle is the 0, 0 coordinates.

The eighth exterior surface 32 is angled relative to the first interior surface 20 at an angle greater than 90 degrees and less than 180 degrees when going in a counterclockwise direction and starting the line drawn parallel or along first interior surface. The angle is more preferably between 130 and 150 degrees. The preferred angle shown is 140 degrees. The eighth exterior surface 32 is angled relative to the second interior surface 22 at an angle less than 90 degrees when going in a clockwise direction and starting from the line drawn along or parallel to the second interior surface. The angle is more preferably between 30 and 50 degrees. The preferred angle shown is 40 degrees. The eighth exterior surface 32 is angled relative to the first line perpendicular 25′ at an angle of greater than 90 degrees and less than 180 when going in a counterclockwise direction and starting from the eighth exterior surface 32. The angle is more preferably between 120 and 140 degrees. The preferred angle shown is 130 degrees; The eighth exterior surface 32 is angled relative to the second line perpendicular 37′ at an angle of greater than 90 degrees and less than 180 degrees when going in a counterclockwise direction and starting from the second line perpendicular. The angle is more preferably between 130 and 150 degrees. The preferred angle shown is 140 degrees.

The eighth portion 31 is angled relative to the third portion 33 going in a counterclockwise direction and starting from a line drawn along the third interior surface 33′ at less than 90 degrees. The angle is more preferably between 40 and 60 degrees. The preferred angle shown is 50 degrees. The eighth portion 31 is angled from the fourth portion 35 going in a clockwise direction from the fourth interior surface 35′ at greater than 90 degrees and less than 180 degrees. The angle is more preferably between 120 and 140 degrees. The preferred angle shown is 130 degrees. The eighth portion 31 is angled relative to fifth portion 39 to form an interior angle greater than 180 degrees and less than 270 degrees. The angle is 230 degrees.

The eighth portion 31 has a first end at the fourth end 12d of the reservoir. The end contacts the fourth portion 35 at an end of the fourth portion 35, opposite where the second portion 18 contacts the fourth portion 35. A second end of the eighth portion is neither at the third end 12c or the first end 12a of the reservoir. This opposite end contacts an end of the fifth portion 39. The end of the fifth portion 39 contacted is the end opposite the end of the fifth portion 39 at the first end 12a.

The fifth portion 39 is angled relative to the first portion to form an interior angle of 90 degrees. Also the second portion 18 is angled relative to sixth portion 97 to form an interior angle of 90 degrees. The sixth portion 97 is angled relative to the seventh portion 100 to form an exterior angle of 90 degrees. The seventh portion 100 is angled relative to the third portion 33 to form an interior angle of 90 degrees. The term interior to describe the angles of the reservoir portions means the angle is in the hollow.

The reservoir has a first side portion 103 with a first side exterior surface 103″ and interior surface 103′. The first side exterior surface 103″ faces a direction opposite the direction the first side interior surface 103′ faces. The first side interior surface 103′ and the first side exterior surface 103″, respectively, each completely lie in a single respective plane and are each planar. The first side portion 103 is at a first side of the reservoir. The first interior side surface 103′ is at a first interior side 103′″ of the reservoir. The first interior surface 103′ at interior side 103′″ delimits the hollow chamber 15 of the reservoir going from the chamber 15 in the direction towards the first side 12e of the reservoir. The first interior side surface 103′ delimiting the hollow 15 is continuous. The first side portion 103 is coupled to and continuously joins reservoir portions one through eight 17, 18, 33, 35, 39, 97, 100, and 31 to one another. The joinder is at the first side 12e of the reservoir. The side portion 103 overlaps first side surfaces 17a, 18a, 33a, 35a, 39a, 97a, 100a, and 31a of the reservoir portions one through eight. Each of the first side surfaces of reservoir portions one through eight has a tab 105 extending therefrom. The first side portion 103 has openings 103a therein adapted and arranged near a perimeter of the side portion 103 to receive the tabs 105 of reservoir portions one through eight. The complimentary tabs 105 and openings 103a allow for aligning and locating the first side portion 103 with the first side surfaces of reservoir portions one through eight at the first side 12e of the reservoir.

The reservoir has a second side portion 107 with a second side exterior 107″ surface and interior surface 107′. The second side exterior surface 107″ faces a direction opposite the direction the first side interior surface 107′ faces. The second side interior surface 107′ and the second side exterior surface 107″, respectively, each completely lie in a single respective plane and are each planar. The second side portion 107 is at a second side 12f of the reservoir. The second side interior surface 107′ delimits a second interior side 107′″ of the reservoir. The second interior side surface 107′ at the second interior side 107′″ delimits the hollow chamber 15 of the reservoir going from the chamber 15 in the direction towards the second side 12f of the reservoir. The second side interior surface 107′ delimiting the hollow chamber 15 is continuous. The second side portion 107 is coupled to and continuously joins reservoir portions one through eight 17, 18, 33, 35, 39, 97, 100, and 31 to one another. The joinder is at the second side 12f of the reservoir. The second side portion 107 overlaps second side surfaces 17b, 18b, 33b, 39b, 97b, 100b, and 31b of reservoir portions one through eight. Each of the second side surfaces of reservoir portions one through eight has a tab 109 extending therefrom. The second side portion 107 has openings 111 therein adapted and arranged near a perimeter of the side portion 107 to receive the tabs 109 of reservoir portions one through eight. The complimentary tabs 109 and openings 111 allow for locating and aligning the second side portion 107 with second side surfaces of reservoir portions one through eight at the second side of the reservoir.

The first side portion 103 and its interior 103′ and exterior 103″ surface are, respectively, parallel to the second side portion 107 and its interior 107′ and exterior 107″ surfaces. The distance measured along a shortest straight line from the first interior side surface 103′ to the second interior side surface 107″ is the interior width of the reservoir 12. The width is less than the interior depth 37 and height 25. The distance measured along a shortest straight line from the first exterior side surface 103″ to the second exterior side surface 107″ is the exterior width of the reservoir. The exterior width is less than the exterior depth and height of the reservoir.

The first 103 and second 107 side portions are each a single, monolithic, seamless piece. Each piece 103, 107, when aligned with tabs 105, 109 overlaps first and second side surfaces of reservoir portions one through eight by 3.175 mm's. The overlap allows for a fillet weld to portions 1-8. Each piece 103, 107 is 14 gauge stainless steel and is considered sheet metal.

The first 103 and second 107 side portions each have mounting tabs 113 with openings at their perimeter. The tabs 113 with openings allow for mounting of the reservoir 12 to the frame 47. The openings are formed with threaded sleeves 113′. The first side portion 103 and the second side portion 107 could be coupled to reservoir portions one through eight without overlapping the side surfaces of reservoir portions one through eight. In this case the first 103 and second 107 sides would be overlapped by reservoir portions one through eight and the tabs 105, 109 and openings 103a, 111 would be reversed.

Reservoir portions one 17, four 35, five 39 and eight 31 and their respective interior surface, exterior surface and side surfaces are formed as a unitary piece. The piece 115 has a sheet like construction wherein the sheet has reservoir portions angled relative to one another as described above. Reservoir portions two 18, three 33, six 97 and seven 100 and their respective interior, exterior, and side surfaces are formed as a unitary piece. The piece 117 has a sheet like construction wherein the sheet has reservoir portions angled relative to one another as described above. The pieces 115 and 117 are each monolithic, singular, and are seamless. The pieces 115 and 117 are laser cut and are fillet welded to each other. Reservoir first portion 17 overlaps reservoir third portion 33 and reservoir second portion 18 overlaps reservoir fourth portion 35 by 3.175 mm's and each portion 17 and 33 has a complimentary tab and through opening locating system, tabs 105 and openings 103, to align pieces 115 and 117. Alternatively, piece 115 could be monolithic with second reservoir portion 18 as opposed to reservoir portion one 17 and piece 117 could be monolithic with first reservoir portion 17 as opposed to portion two 18. The pieces are made of 14 gauge stainless steel. The pieces are sheet metal.

A through opening 123 passes through the reservoir and opens onto the hollow chamber 15. Filter 81, which extends into the hollow chamber 15, is coupled to the reservoir proximate the through opening 123 and extends through the through opening 123. The through opening 123 extends through the second portion 18 and the second interior 22 and exterior surfaces 23. The filter 81 has a fluid inlet port 54″ into which the fill entry 54′ opens. The fill entry 54′ is covered by fill entry closure 54. Hydraulic fluid, which has entered the filter 81 through inlet 54″ or fill entry 54′, exits the filter through fluid outlet port 81a′.

The inlet port 54″ is coupled to a fitting 125a. The fitting forms part of a conduit 125 which receives hydraulic fluid from the heat exchanger 127 and directs the fluid into the filter 81. The conduit 125 is a low pressure return conduit. The heat exchanger 127 receives the hydraulic fluid from the control block 137 by way of conduit 202. The fitting 125a also forms part of a conduit 131 which receives fluid directly from the control block 137. The conduit 131 receives hydraulic fluid from the block 137 after the fluid has done work and directs it to the filter 81. The conduit 131 is a bypass conduit which allows the fluid after it has done work to bypass the heat exchanger 127. The filter 81 can also have an inlet 81b to receive hydraulic fluid after it has powered the hydraulic fan motor 159. In this case the inlet is coupled to a conduit 133 which includes a fitting. The conduit 133 receives hydraulic fluid from the fan motor 159 and directs it to the filter. Conduit 200 directs high pressure hydraulic fluid from the control block to the fan motor 159.

The inlets 54″ and 81b are formed in a head 81a′″ of the housing 81a. The outlet 81a′ is formed in the bowl 81a″″ of the housing 81a. The housing 81a has a long axis. The long axis extends through the filter outlet port 81a′. The outlet 81a′ is within the hollow chamber 15 of the reservoir.

The filter 81 is coupled to the reservoir by fasteners 82. The head 81a′″ is coupled to the reservoir at the second exterior surface 23 by fasteners 82. The fasteners include lugs which extend away from the second exterior surface 23 through openings in the head. A gasket between the head and the second exterior surface helps seal the filter 81 to the reservoir 12. The head forms the fill entry 54′. The movable closure 54, in a closed position, covers the fill entry 54′ and in an open position uncovers, at least partially, the fill entry 54′. The closure 54 is a removable cap. When the closure is in the open position, removed, an operator fills the reservoir 12 by transmitting hydraulic fluid through the fill entry 54′. The head 81a′″ also has pressure relief vents, not shown, which allow the reservoir 12 to vent pressure, especially when being filled with hydraulic fluid.

A through opening 141 extends through the reservoir 12 and opens into the hollow chamber 15 proximate the interior bottom of the reservoir. The through opening 141 has a fitting 141a installed therein that receives a drain plug 141′ installed therein. The through opening extends through the third portion 33 and its interior and exterior surfaces.

A conduit, not shown, is fluidly coupled to the reservoir by its fitting. The conduit couples to a pump. The pump draws the fluid out of the reservoir through the conduit coupled to one of the fittings 71, 75 of its respective suction port 72, 77. When the port is not going to be used in connection with a particular truck installation it is covered by a plug 80.

The frame 47 has a depth, width and height, respectively, oriented along the same directions as the interior depth, interior width and interior height of the reservoir. The frame 47 has a front, rear, first side, second side, top and bottom, respectively, oriented along the same directions as the front, rear, first side, second side, top, and bottom of the reservoir. The frame's front, rear, first side, second side, top and bottom, respectively, are oriented along the same directions as the front, rear, first side, second side, top, and bottom of the cooling assembly. The bottom, top, rear, and front sides of the frame are respectively at the first end 47a, second end 47b, third end 47c, and fourth end 47d of the frame 47.

A first portion 48 of the frame 47 has a first interior 48a and exterior 48b surface, respectively, at an interior and exterior side of the first portion 48. The first exterior 48a and interior 48b surfaces are planar. The first portion 48 is made of sheet metal. An air port 48c, circumscribed at its perimeter by a fan ring 49 at the interior side, extends through the first portion 48 and its exterior and interior surface. The ring 49 can be alternatively called a collar. The first portion 48 is at the bottom of the frame 47 and at the first end 47a of the frame; the first exterior surface 48b delimits an exterior bottom and exterior first end 47a of the frame 47; the first interior surface 48a delimits an interior bottom and first interior end of the frame. The first portion 48 has a fourth end 48d with a fourth end surface 48d′, a third end 48e with a third end surface 48e′, a first end 48f with a first end surface, and a second end 48g with a second end surface, respectively, at the fourth end 47d, the third end 47c, first side 47e, and second side 47f of the frame 47. A first border member 147 at the fourth end 48d extends from the first end 48f to the second end 48g of the first portion 48 and away from the first interior surface 48a. The border member 147 is integral and seamless with the first portion 48. The first border member 147 is a portion of portion 48 and is bent upwards to extend away from the first interior surface 48a.

A second border member 148 extends away from the fourth end 48d towards the third end 48e of the first portion 48. It extends to the third end 48e from the fourth end 48d. It extends at the first end 48f of the first portion 48 away from the first interior surface 48a. It overlaps the first end surface of the first frame portion 48. A third border member 149 extends away from the fourth end 48d towards the third end 48e of the first portion 48. It extends to the third end 48e and from the fourth end 48d. It extends at the second end 48g of the first portion 48 and away from the first interior surface 48a. It overlaps the second end surface of the first frame portion. Extending in a direction away from the first portion 48 and towards the second end 47b of the frame is second frame portion 59 which is a first upright. The first upright 59 is closer to the frame's third end 47c and first side 47e than it is, respectively, to the frames fourth end 47d and second side 47f Extending in a direction away from the first portion 48 and towards the second end 47b of the frame 47 is third frame portion 61 which is a second upright. The second upright 61 is closer to the frame's third end 47c and second side 47f than it is, respectively, to the frame's fourth end 47d and first side 47e. The uprights 59 and 61 are opposite each other. Each upright 59 and 61 is coupled to the first frame portion 48.

Both the first 59 and second 61 uprights are located the same distance from the first portion fourth end 48d towards the first portion third end 48e. Each upright is about ⅚ of the distance to the third end surface 48e′ of the first portion 48. The uprights 59, 61 are near a line extending from the first end 48f to the second end 48g of the first portion. The line is tangent a point on the ring 49 closest the third end 48e of the first portion 48. Both the first and second uprights 59, 61 each have mounting areas 59a, 61a with openings therein. The areas 59a, 61a receive fasteners which couple to the mount tabs and extend into the sleeves 113′, on the reservoir first 103 and second 107 side portions. The fasteners couple the reservoir 12 to the frame 47 at the uprights 59, 61. The open areas 58, 60 described above are formed in uprights 59, 61.

The first upright 59 and the second border 148 are a unitary, single, monolithic, seamless piece forming an L shape. The second upright 61 and the third border 149 are a unitary, single, monolithic, seamless piece forming an L shape.

Each upright 59, 61 has an end 59b, 61b opposite the first portion 48. These ends, opposite the frame first end 47a, are at the second end 47b of the frame. A cross member 151, which is a flat rectangular sheet metal piece, extends away from the first upright 59 to the second upright 61. The cross member 151 contacts each upright at opposite ends of the cross member 151. The cross member is proximate ends 59b, 61b. The cross member 151 has a planar exterior surface 151a which faces away from the first portion 48 first interior side 48a.

A mounting member 153 is coupled to the uprights 59, 61. The mounting member 153 is a mounting plate. The member 153 has an exterior 153b and interior 153a surface, respectively, at an exterior and interior side of the mounting member 153. The interior 153a and exterior 153b surfaces are planar. The exterior surface 153b faces away from the frame fourth end 47d and the interior surface 153a faces towards the frame fourth end 47d. The mounting member 153 is perpendicular to the first portion 48. The mounting member 153 is where the frame 47 is coupled to a frame rail 157 of a truck. The mounting member 153 has though openings 153c which extend though the member 153 and its exterior and interior surfaces 153a, 153b. The through openings 153c receive coupling hardware, not shown, which couples the frame 47 to the frame rail 157. When the frame 47 is coupled to the frame rail 157, the mounting exterior surface 153b faces an outward facing surface 157b of the frame rail. The surface 157b extends in a direction along a line extending from the top of the rail to a bottom of the rail. The surface also extends in the direction of the long axis of the frame rail 157. The term outward, as used in connection with the frame rail 157, means a direction facing away from an inward end of the rail and facing away from a central area delimited by the truck's frame rails, one of which is shown as 157. The mounting member 153, as explained more fully below, allows for the frame 47 and assembly to be coupled to the frame rail 157 with a particular orientation relative to the frame rail 157.

The frame 47 includes a control block mount 140. The control block mount 140 has a first surface 140a, on a first side, facing the frame first end 47a. The mount has a second surface 140b, on a second side, facing the frame second end 47b. The first and second surfaces are parallel to the first portion 48 of the frame 47. The control block 137 is coupled to the control block mount 140 and mounted to the mount 140 on the first side of the mount. The first surface 140a faces the control block. The second surface 140b faces away from the control block. The control block has a side with a surface 137b that faces away from the frame fourth end 47d. The surface has a high pressure port 137b′ and a return port 137b″. The high pressure port connects to a portion of a conduit such as its “T” fitting 138. High pressure fluid used to power a hydraulic fan motor 159 of the assembly is directed to and into the block 137 through the conduit including its fitting 138. The return port 137b″, low pressure port, connects to a portion of a conduit such as its fitting 139. Low pressure hydraulic fluid to be cooled by the heat exchanger 127 of the assembly, after it has performed work, is directed to and in into the block through the conduit including its fitting 139. The control block 137 can include an auxiliary port 143 to couple to an auxiliary device, such as a pressure gauge, to the control block. The control block can further include another port to couple to a pressure relief valve.

The frame 47 includes a fan motor mount 161. The fan motor mount 161 has portions 161a, 161b, legs, which extend in a direction away from the frame first end 47a towards the frame second end 47b. The legs 161a, 161 b extend away from the first portion interior surface 48a. The legs are couple to the first portion 48. A first pair of first legs 161a and a second pair of second leg 161b are about the air port 48c. The pairs are at opposite sides of the air port 48c. The fan motor mount 161 has a portion 161c which extends from the first pair of legs to the second pair of legs. The portion 161c, which is a cross member, overlaps and spans across the air port 48c. The cross member 161c is coupled to the legs. The portion 161c has a first surface 161c′ facing away from the frame first end 47a and in the direction of the frame second end 47b. The portion 161c has a second surface facing away from the frame second end 47b towards the frame first end 47a. The cross member, portion 161c, can have fasteners such as threaded lugs 162, extending in a direction away from the first surface 161c′ and away from the first end 47a of the frame 47. The lugs 162 couple the fan motor 159 to the mount 161. The cross member 161c defines an opening 161d through which a shaft coupled to the fan motor 159 extends when the motor 159 is coupled to the mount 161. Once the motor 159 is coupled to the mount 161, the fan 163, having a plurality of blades, is coupled to the shaft. The fan 163, when coupled to the shaft of the motor, and the motor 159 is coupled to the mount 161, is oriented to have a portion of the fan's blades circumscribed by the fan ring 49. The fan's 163 blades overlap the air port 48c. The frame is made of 14 gauge sheet metal.

A fan cover 164, which is a fan grate, is coupled to the frame 47 to overlap the air port 48c and the fan's 163 blades. The fan cover 164 is at the first exterior side of the first portion 48 and first end 47a of the frame. It is coupled to the first portion 48 at the first exterior surface 48b.

The frame 47 carries the heat exchanger 127. The heat exchanger 127 is coupled to the frame 47. It is couple to the first portion 48 at the first portion 48 interior side. Rotation of the fan 163 draws air into air chamber 166 through the port 48c. Air is drawn in from the environment. The air drawn into air chamber 166 through port 48c, now tasked as an inlet port, exits the air chamber 166 by passing through the heat exchanger 127. The air, to pass through the heat exchanger 127, first enters the heat exchanger by entering open passages at the heat exchanger second side 127b. The heat exchanger 127 has a first side 127a, opposite the second side 127b. Air entering the open passages at the second side 127b from the air chamber 166, exits the heat exchanger 127 and open passages at the heat exchanger first side 127a. The air exiting the heat exchanger exits into the environment. Angled exterior surface 32 of the eighth reservoir portion 31 deflects at least some of the air drawn into the air box before it is exhausted through the heat exchanger 127. The passing of the air through the heat exchanger cools the hydraulic fluid passing through the heat exchanger. A first surface 127a′ at the first side 127a and a second surface 127b′ at the second side 127b, border the open passages. Surfaces 127b′ and 127a′ have been simplified for ease of discussion. A surface 127b″, on the second side 127b, is about the second surface 127b′ and delimits the air chamber 166 in a first horizontal direction 400 going from the air chamber 166 towards the frame fourth end 47d. The air chamber 166 is within an air box. The fan motor 159 is in the air chamber 166. The air inlet port 48c opens into the air chamber from the environment.

As an alternative to the above described air-flow, rotation of fan 163 could draw air from the environment into air chamber 166 through heat exchanger 127 and exhaust the air through port 48c. The air drawn into the air chamber 166 would first pass from the environment into the heat exchanger open passages at first side 127a. The air entering the heat exchanger at the first side 127a would exit the heat exchanger 127 and its open passages at the second side 127b. The air then enters the air chamber 166. The air would be exhausted into the environment from the air chamber 166 through port 48c, now an exhaust port. Air would be deflected by angled exterior surface 32.

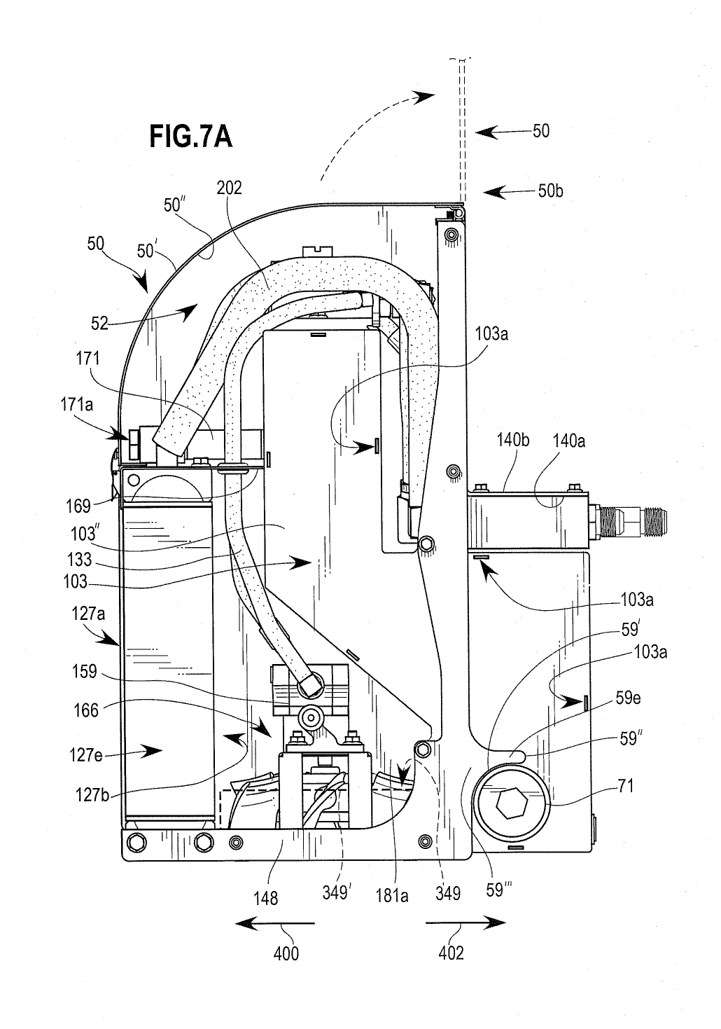

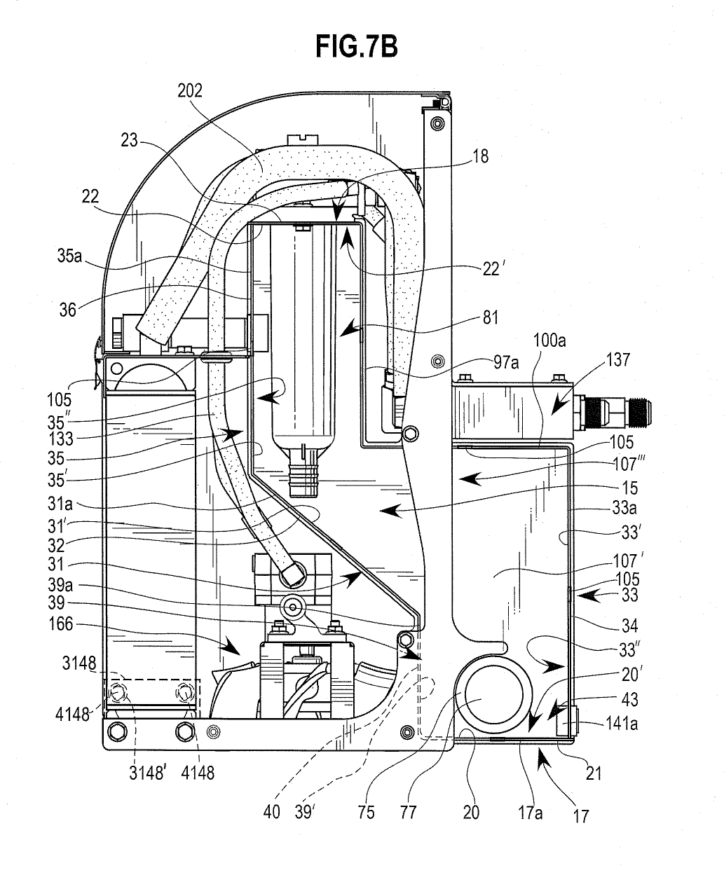

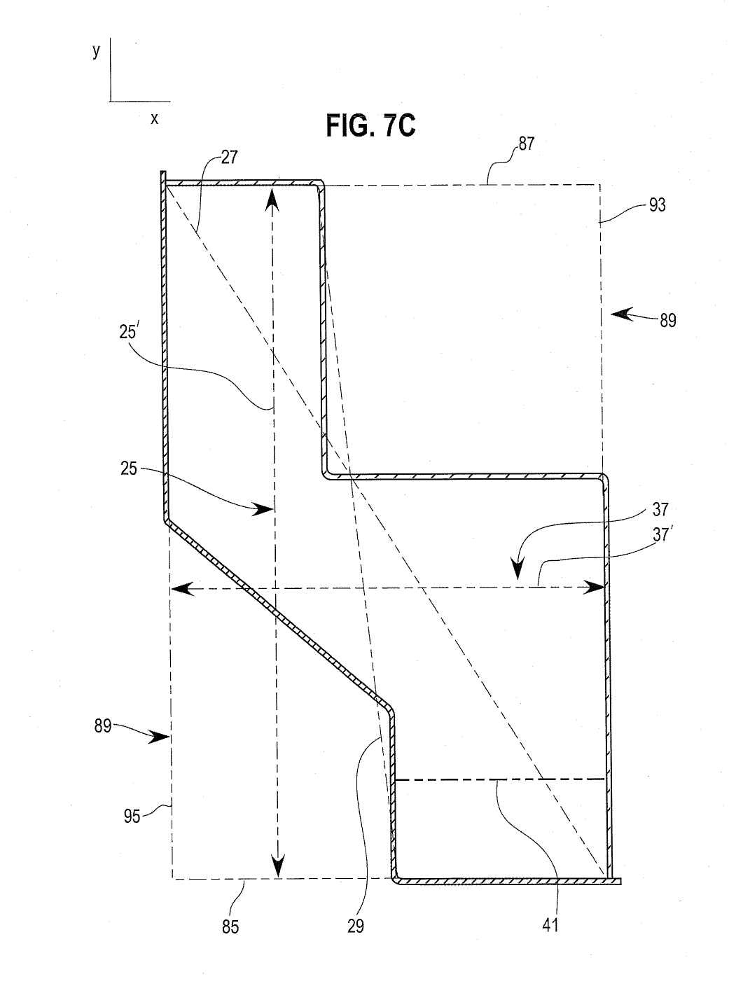

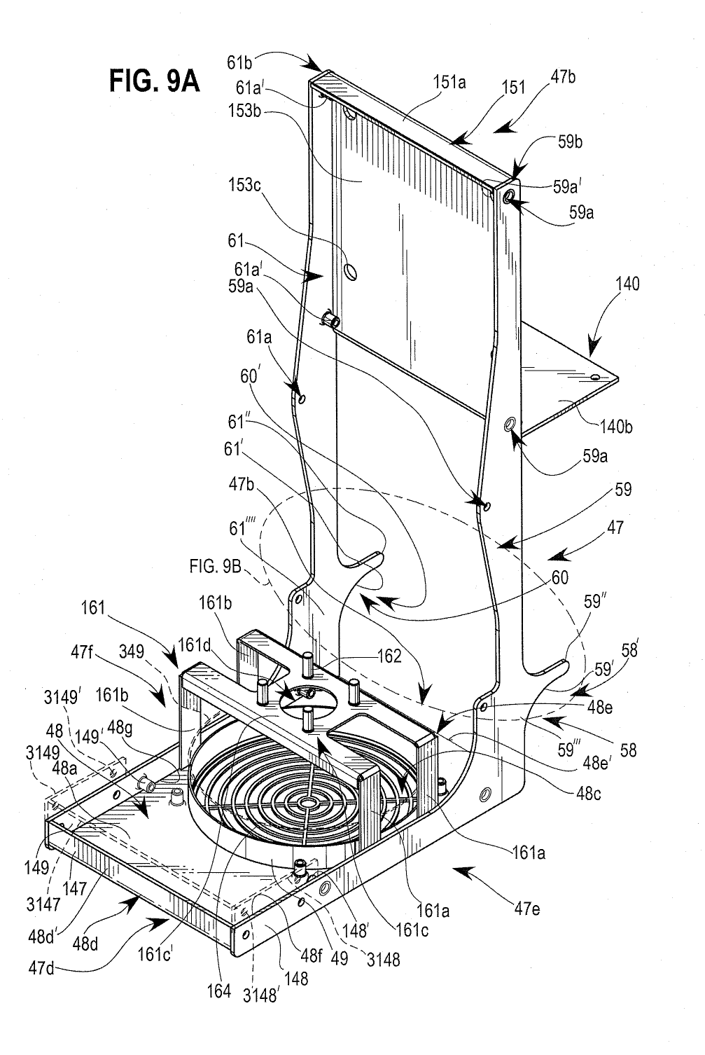

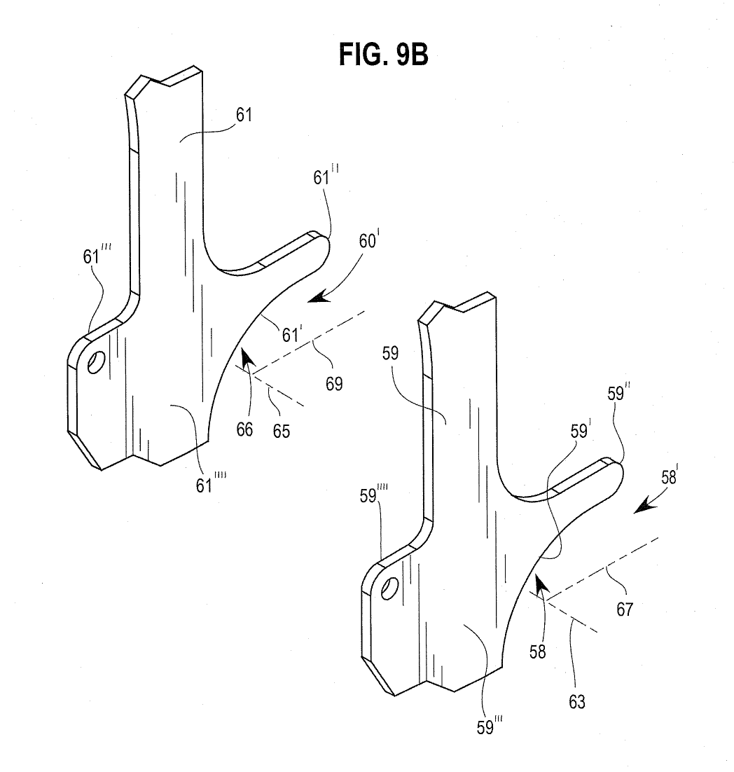

For configurations in which air flow is drawn into air chamber 166 through the heat exchanger 127 by fan 163, a fan ring with a vertical length (height) greater than fan ring 49 can be used. The vertical height/length is measured in direction 91 from the frame first end 47a to the frame second end 47b. Increasing the vertical height of the fan ring 49 from 2.90 cm to a height of 8.65 cm provides for the upper edge 349′ of the fan ring 349 to be of even height with the leading edge of fan blades. The fan ring with the increased vertical height is preferred when drawing air into the air-chamber 166 through heat exchanger 127. The fan ring upper edge 349′ is shown in dotted line in FIGS. 7A, 7B, 9B. The upper edge 349′ is closer to frame end 47b than the upper edge of fan ring 49. The fan ring 349 with greater height encompasses more of the fan in the vertical direction. If a fan ring of increased height were used, one would modify the construction in a manner well within the skill in the art. For instance the heat exchanger 127 would be raised away from the frame first end 47a towards the frame second end. To raise the heat exchanger, the vertical height of the second border member 148 at an end of the second border member 148 towards frame fourth end 47d would be increased, and the vertical height of the third border member 149 at an end of the member 149 towards frame fourth end 47d would be increased. The area of increased vertical height, if the second border member were so modified, is shown in dotted lines at 3148, and the area of increased vertical height, if the third border member were so modified, is shown in dotted lines 3149. The vertical height of the mounting holes 3148′ in the area of the raised border member 3148 area would also be increased from where they are in the un-raised area of border member 148. The vertical height of the mounting holes 3149′ in the area of the raised border member 3149 would also be increased from where they are in the un-raised area of border member 149. The mounting holes 3148′, 3149′ receive fasteners 4148 to couple the frame to the heat exchanger 127. The raised members 3148, 3149 and their respective mounting holes 3148′, and 3149′ would be configured to raise the heat exchanger 20-25 cm. Also the vertical height of the first border member 147 would be increased. The upper edge of a first border member 147, with an increased vertical height, is shown with dotted lined 3147. The sight glass 171 would be raised and enter the reservoir at a greater vertical height from first portion 17. The construction, such as the curvature, and length of the closure 50 would change to accommodate the raised heat exchanger and sight glass. The dotted lines, referenced in this paragraph, for convenience have been only included in certain figures and intentionally omitted from various figures.

The heat exchanger 127 has a first 127c and a second 127d end. The first end 127c is oriented, relative to the second end 127d, closer towards the frame first portion 48 than the second end 127d and the exchanger second end 127d is oriented, relative to its first end 127c, closer towards the frame second end 47b than the exchanger first side 127c. The heat exchanger has a third side 127e with a third side surface 127e′ and a fourth side 127f with a fourth side surface 127f′. The third side 127e is oriented, relative to the fourth side 127f, towards the frame first side 47e and the exchanger fourth side 127f is oriented, relative to is third side, towards the frame second side 47f. The first end 127c, of the heat exchanger and portions of the third 127e and fourth 127f sides are in a space delimited by the first 147, second 148 and third 149 border members.

A wall member 169 overlaps the heat exchanger 127 at the exchanger first side 127a and second end 127d. It at least partially covers the second end 127d. The wall member 169 is coupled to the heat exchanger 169. A portion of the wall member 169 extends away from the heat exchanger first 127a and second 127b sides and towards the frame third end 47b. The portion of the wall member 169 extending delimits the air chamber 166 in vertical direction 91 from the air chamber 166 towards the frame second end 47b. A sight glass 171 is mounted to the wall member 169. An end 171b of the sight glass 171, opposite an end 171a through which an operator looks into to determine hydraulic fluid level in the reservoir, extends into the reservoir hollow chamber 15 and into and through an aperture in the reservoir. The aperture is through the reservoir fourth portion 35 and its exterior and interior surface.

The cooling assembly closure 50 carried by the frame 47 has an exterior surface 50″. The closure 50 has a second end 50b which forms part of the top of the assembly. The closure second end 50b is at the second end 47b of the frame and couples to the frame 47 at the second end 47b. The closure second end 50b is hingedly coupled to the frame second end 47b. The hinges 173 are mounted on the cross member 151 of the frame. The closure 50 has a first end 50a which forms part of the fourth end 10a of the assembly and is at the fourth end 47a of the frame. Adjustable latches 175 on the wall member 169 allow for coupling of the closure first end 50a at the fourth end of the assembly and frame. The latches 175 are mounted to the portion of the wall member 169 overlapping the heat exchanger first side 127a. The catch to which the latch couples is mounted at the first end 50a of the closure 50. The closure continuously extends from its first end 50a to its second end 50b. The closure interior surface 50′ and exterior surface 50′ are curved going in the direction from the first end 50a to the second end 50b.

Disposed in the open area 52 are the fill entry closure 54, the reservoir second portion 18, a portion of the reservoir fourth portion 35, the fitting of conduit 131 into the control block 137, and the sight glass 171. When the closure 50 is in the open position, the open area 52 in which the fill entry closure 54, the fitting of conduit 131 into the control block, the reservoir second portion 18, the portion of the reservoir fourth portion 35, and the sight glass 171 are disposed, is open to the environment exterior to the closure 50. When the closure is in the open position, the open area 52 and the closure 54 of the fill entry 54′ are accessible by the hands of an operator. The open area 52, when the closure 50 is in the closed position, is relatively closed off form the environment exterior. The operator opens the closure to the open position from the closed position by uncoupling the latches 175 from catches. The closure is than pivoted to move its first end 50 away from the frame first end 47a.

The frame 47 carries first and second side members which are panels 179, 181. The first and second side panels 179, 181 each have exterior 179b, 181b and interior 179a, 181a surfaces. The first panel 179 is at the first side 47a of the frame 47 and the first side 10a of the assembly. The second panel 181 is at the second side 47b of the frame 47 and a second side 47b of the assembly. The first side interior surface 179a delimits a side of the air chamber 166 going in a direction from the air chamber 166 to the assembly's first side 10a. The second side interior surface 181a delimits the air chamber 166 going in a direction from the air chamber 166 to the assembly's second side 10b. Each first and second side 179, 181 is coupled to the frame 47.

The first and second side 181 panels each have first 179c, 181c and second 179d, 181d ends. The first ends 179c, 181c are at the first end 47a the frame. The second ends 179d, 181d are opposite the first end 47a of the frame 47. At least a portion of the closure 50 spans an area between the first 179 and second side 181 panels. The closure 50 overlaps the second ends 179d, 181 d of the side panels 179, 181. The first side panel 179 has openings 179e which receive fasteners that extend into the openings in mount areas 59a of upright 59; and openings 179e which receive fasteners that extend in openings of second border member 148. The openings in the mount areas 59a that do not align with tabs 113 of reservoir 12 are formed with threaded sleeves 59a′ which receive the fasteners. The openings in second border 148 which fasten to the side panel 179 are formed with sleeves 148′ that receive the fasteners. The second side panel 181 has openings 181e which receive fasteners that extend into openings in mount areas 61a of upright 61 and openings 181e which receive fasteners that extend into openings of third border member 149. The openings in the mount areas 61a that do not align with tabs 113 of reservoir 12 are formed with threaded sleeves 61a′ that receive the fasteners. The openings in third border 149 which fasten to the side panel 181 are also formed with sleeves 149′.

The truck frame rail 157 has the bottom formed by a bottom facing surface 157c and an opposite facing top facing surface 157a which forms the top. The bottom facing surface 157c and the top facing surface 157a each extend from the outward facing surface 157b, at opposite ends of the outward facing surface 157b, towards the inward end 157d of the rail. The inward end 157d is closer to the central area delimited by the truck's frame rails than the outward facing surface. The outward surface 157b is at the outward end 157e of the rail. The bottom surface 157c forms an underside of the rail. The bottom facing surface 157c is oriented, relative to the top facing surface 157a, closer to the ground 190 than the top facing surface 157a; and the top facing surface 157a is oriented, relative to the bottom surface 157c, further from the ground 190 than the bottom facing surface 157c. The outward end 157e is further from the central area than the inward end 157d. The bottom surface 157c faces towards the ground 190 upon which the truck having the rail sits. The height of the rail 157 is the distance from the top surface 157a to the bottom surface 157c. The width of the rail is measured from the outward end 157e to the rail inward end 157d. The length of the rail is measured along the rails long axis. The height can be measured along the outward surface 157b, and the width can be measured along the bottom 157e or top 157a surface. When the assembly 10 is mounted to the rail 157, at least a portion of the reservoir 12, control block 137, control block mount 140, each overlap the bottom surface 157c and bottom of the rail; at least a portion of the reservoir first portion 17, reservoir first end 12a, reservoir second portion 18, reservoir second end 12b, each overlap the bottom surface 157c and bottom of the rail; at least a portion of the control block surface 137b, control block mount surface 140b, reservoir first interior surface 20, reservoir second exterior surface 23 are opposite and face the bottom surface 157c. A portion of the reservoir 12 extends inward of the rail. A portion of the first interior surface and a portion of the second interior surface extend inward of the rail. The assembly third end 10c and reservoir third end 12c and reservoir third portion are inward of the rail 157. By being inward the items are further from the outward end 157e and surface 157b than from the inward end 157d and surface 157b. Portions of the assembly, such as the closure 50 and filter 81 overlap the outward surface 157b but do not overlap the bottom surface 157c. The assembly fourth end 10d, frame fourth end 47d, and heat exchanger 127 are outward of the rail outward surface 157b and end 157e. By being outward the items are further from the inward end 157d than the outward end 157e and surface 157b.

In more detail the reservoir first portion 17 is oriented closer towards the frame first portion 48 than is the reservoir second portion 18. The reservoir third 33 and fifth 39 portions are oriented closer to the frame third end 47c than is the reservoir fourth portion 35. The reservoir fifth portion 39 is oriented closer to uprights 59, 61 than is either reservoir third 33 or fourth 35 portion. The fourth portion 35 is oriented closer to the frame fourth end 47d than is the reservoir fifth 39 and third portions 33. The reservoir second 18, fourth 35, and sixth 97 portions and reservoir opening 123 are between the assembly fourth end 10d and a straight line connecting uprights 59, 61. The line is along ends of each upright 59, 61 closest to the assembly fourth end 10d. The reservoir second 18, fourth 35 and sixth 97 portions and reservoir opening 123 are forward of the uprights 59, 61. The distances of the reservoir portions to the frame portions described in this paragraph are measured along a shortest straight from the reservoir portion to the frame portion.

The reservoir third portion 33 is at the third end 10c of the assembly and delimits the assembly at the third end 10c. The third portion 33 is spaced away from the frame third end 47c going in a direction away from the frame fourth 47d and third end 47c. The third end 33 and third portion 33 of the reservoir are each not between the frame fourth end 47d and third end 47c. A portion of the fame first portion 48 is at the first end of the first end 10a of the assembly.

A portion of reservoir fourth exterior surface 36 and at least a portion of the reservoir fifth exterior surface 40, and the reservoir eighth exterior surface 32 delimit the air chamber 166 going in the second horizontal direction 402 from the air chamber 166 towards the frame third end 47c. The eighth exterior surface 32 also delimits the air chamber 166 in the vertical direction 91 from the air chamber 166 to the frame second end 47b.

The fourth end 10d of the assembly is the front of the assembly and the second end 10b is the top of the assembly. The first end 10a of the assembly is the bottom. The third end 10c is the rear.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A mobile hydraulic cooling assembly having a hydraulic fluid reservoir, said reservoir having a plurality of reservoir portions each reservoir portion of said plurality having an interior surface, each of said plurality of interior surfaces delimits a same hollow chamber of said reservoir; each of said plurality of interior surfaces forming an entirety of surfaces delimiting the hollow chamber, said cooling assembly adapted to be mounted to a truck frame rail, wherein:
a first reservoir portion of said plurality of reservoir portions has a first interior surface of said plurality of said interior surfaces;
a second reservoir portion of said plurality of reservoir portions has a second interior surface of said plurality of interior surfaces;
said first internal surface and said second internal surface are spaced apart a vertical distance in a vertical direction;
at least a portion of the second interior surface is offset from the first interior surface in a horizontal direction perpendicular to the vertical direction, and the portion of the second surface offset is not opposite any of the first interior surface in the vertical direction;
a longest straight line extending from the portion of the second interior surface offset to the first interior surface intersects a line extending along said vertical direction at an angle greater than 90 degrees and less than 180 degrees.

2. The mobile hydraulic cooling assembly of claim 1 wherein a shortest straight line extending from the first interior surface to the second interior surface intersects the line extending along the vertical direction at an angle of greater than 90 degrees and less than 180 degrees.

3. The mobile hydraulic cooling assembly of claim 1 wherein:
a third reservoir portion of said plurality of reservoir portions has a third interior surface of said plurality of interior surfaces;
a fourth reservoir portion of said plurality of reservoir portions has a fourth interior surface of said plurality of interior surfaces;
a fifth reservoir portion of said plurality of reservoir portions has a fifth interior surface of said plurality of interior surfaces, at least a portion of the third interior surface and a portion of the fifth interior surface are opposite each other going in the horizontal direction;
said third interior surface and fourth interior surface are spaced apart a distance measured in the horizontal direction;
a shortest straight line distance between the portions of the third and fifth interior surfaces opposite each other is Y; the distance Y is less than the horizontal distance which the third and fourth internal surfaces are spaced.

4. The mobile hydraulic cooling assembly of claim 3 wherein the portions of the third interior and fifth interior surfaces opposite each other form part of a sump area of the reservoir.

5. The mobile hydraulic cooling assembly of claim 1 wherein the assembly further comprises a frame coupled to the reservoir.

6. The mobile hydraulic cooling assembly of claim 5 further comprising:
a closure moveable from a closed position to an open position and vice versa, said closure carried by said frame,
a fill entry closure covering a fill entry into the reservoir
wherein the closure moveable from the closed position to the open position has an interior surface delimiting an open area in the assembly
wherein the fill entry closure is disposed in the open area, and when the closure moveable is in the open position, the open area is open to an environment exterior to the closure moveable; and the fill entry closure is accessible by the hands of an operator; and the operator can move the fill entry closure to an open position and fill the reservoir; and
wherein when the closure moveable between the open and closed position is in the closed position, the closure moveable closes off the open area so it is not accessible by the hands of an operator.

7. The mobile hydraulic cooling assembly of claim 5 further comprising:
a first open area delimited by a first curved wall of a first respective frame portion of said frame, said first curved wall is proximate a first fitting forming a first suction port, said first suction port is at a first side portion of said reservoir;

8. The mobile hydraulic cooling assembly of claim 7 further wherein
said first curved wall provides an abutment for the first fitting and reduces strain on a connection between the first fitting and the first side portion when a respective conduit is coupled to the first fitting.

9. The mobile hydraulic cooling assembly of claim 7 wherein
said first curved wall delimits the first open area in a direction wherein a vector drawn in the direction delimited has a component going in the vertical direction and a component going in the horizontal direction.

10. The mobile hydraulic cooling assembly of claim 7 wherein
a flange of said first respective frame portion forms at least part of said first curved wall.

11. The mobile hydraulic cooling assembly of claim 1 further comprising:
a filter extending into the reservoir hollow chamber, and a fluid outlet is formed in a housing of the filter;
wherein an end surface delimiting an exterior end of the fluid outlet is submerged in hydraulic fluid in the reservoir when the cooling assembly is under normal operation; the end surface is spaced from the surface of the hydraulic fluid a distance in the vertical direction.

12. The mobile hydraulic cooling assembly of claim 11 further wherein:
the distance the end surface is spaced from the surface of the hydraulic fluid is a minimum distance of 13 cm.

13. The mobile hydraulic cooling assembly of claim 11 wherein:
the end surface is spaced from the second interior surface of the second reservoir portion a distance, measured in the vertical direction of 25 cm; said second portion is at a top of said reservoir.

14. The mobile hydraulic cooling assembly of claim 1 wherein:
an angled reservoir portion of said plurality of reservoir portions has an angled interior surface of said plurality of interior surfaces, the angled interior surface is angled relative to the first interior surface at an angle greater than 90 degrees and less than 180 degrees when going in a counterclockwise direction and starting from the a line drawn parallel to the first interior surface.

15. The mobile hydraulic cooling assembly of claim 14 wherein:
the angle is between 130 and 150 degrees.

16. The mobile hydraulic cooling assembly of claim 14 wherein:
the angled interior surface is angled relative to the second interior surface at an angle of less than 90 degrees when going in the clockwise direction and starting from a line drawn parallel to the second interior surface.

17. The mobile hydraulic cooling assembly of claim 16 wherein:
the angle is between 30 and 50 degrees.

18. The mobile hydraulic cooling assembly of claim 14 wherein:
the angled interior surface intersects a vertical line drawn along the vertical direction at an angle of 130 degrees.

19. The mobile hydraulic cooling assembly of claim 18 wherein:
the angle is between 120 and 140 degrees.

20. The mobile hydraulic cooling assembly of claim 3 wherein:
an angled reservoir portion of said plurality of reservoir portions has an angled interior surface of said plurality of interior surfaces, the angled interior surface is angled relative to the first interior surface at an angle greater than 90 degrees and less than 180 degrees when going in a counterclockwise direction and starting from the a line drawn parallel to the first interior surface;
said angled reservoir portion has an angled exterior surface; said exterior surface angled relative to said line drawn in the vertical direction at an angle of greater than 90 degrees and less than 180 when going in a counterclockwise direction and starting from the angled exterior surface.

21. The mobile hydraulic cooling assembly of claim 3 further comprising:
a heat exchanger;
an air chamber;
wherein the fourth reservoir portion has a fourth exterior surface and said third reservoir portion has a third exterior surface;
wherein at least a portion of said third exterior surface, fourth exterior surface and angled exterior surface delimit the air chamber in a horizontal direction opposite the horizontal direction, said angled exterior surface also delimits the air chamber in the vertical direction; and
wherein
air is drawn into the air chamber through the heat exchanger and exhausted from the air chamber through an exhaust port when the cooling assembly is in operation, or
air is drawn into the air chamber from an inlet port and exhausted form the air chamber through the heat exchanger when the cooling assembly is in operation.

22. The mobile hydraulic cooling assembly of claim 1 wherein:
the truck frame rail comprises:
a bottom formed by a bottom facing surface and a top formed by a top facing surface, said top facing surface faces a direction opposite the bottom facing surface, said bottom facing surface forms an underside of the rail;
an outward end formed by an outward facing surface;
wherein the top facing surface and bottom facing surface each extend away from the outward facing surface, at opposite ends of the outward facing surface to an inward end of the rail; and
wherein the cooling assembly when mounted to the truck frame rail has a particular orientation relative to said rail, wherein at least a portion of two of said plurality of reservoir portions having an interior surface delimiting said hollow chamber overlaps the bottom facing surface and bottom of said rail.

23. The mobile hydraulic cooling assembly of claim 22 wherein:
the portions of the two reservoir portions overlapping the bottom facing surface and bottom of said rail are at least a portion of the reservoir first portion and at least apportion of the reservoir second portion.

24. The mobile hydraulic cooling assembly of claim 23 wherein:
wherein the at least the portion of the reservoir first interior surface and at least a portion of a second exterior surface of said second reservoir portion face the bottom facing surface.

25. The mobile hydraulic cooling assembly of claim 23 wherein:
wherein a portion of the reservoir first portion and a portion of the reservoir second portion each extend inward of the frame rail wherein by being inward of the frame rail these portion are further from the rail outward end than from the rail inward end.

26. The mobile hydraulic cooling assembly of claim 23 wherein:
wherein a third portion of said plurality of reservoir portions is inward of the frame rail.
